(19) United States
(12) Patent Application Publication
(10) Pub. No.: US 2014/0352945 A1
(43) Pub. Date: Dec. 4, 2014

(54) Degrading Wellbore Filtercake with Acid-Producing Microorganisms

(71) Applicant: Halliburton Energy Services, Inc., Houston, TX (US)

(72) Inventors: Achala Vasudev Danait, Pune (IN); Lalit Pandurang Salgaonkar, Pune (IN)

(73) Assignee: Halliburton Energy Services, Inc., Houston, TX (US)

(21) Appl. No.: 13/903,238

(22) Filed: May 28, 2013

(51) Int. Cl. C09K 8/582

(52) U.S. Cl. CPC C09K 8/582
USPC 166/246

(57) ABSTRACT

A method of degrading a filtercake in an interval of a wellbore penetrating a subterranean formation is provided, wherein the filtercake includes a gelled or solid material that can be dissolved or hydrolyzed with an acidic fluid. The method includes the steps of: (A) introducing a treatment fluid into the interval of the wellbore, the treatment fluid comprising: (i) water; and (ii) an acid-producing anaerobic microorganism; and then (B) shutting in the interval of the wellbore.

### CROSS-REFERENCE TO RELATED APPLICATIONS

Not applicable.

### TECHNICAL FIELD

The inventions are in the field of producing crude oil or natural gas from subterranean formations. More specifically, the present invention relates to at least the partial degradation of a filtercake formed in a wellbore. More particularly the present invention provides compositions and methods for degrading of filtercakes.

### BACKGROUND

To produce oil or gas, a well is drilled into a subterranean formation that is an oil or gas reservoir.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a well fluid into a well.

Drilling is the process of drilling the wellbore. After a portion of the wellbore is drilled, sections of steel pipe, referred to as casing, which are slightly smaller in diameter than the borehole, are placed in at least the uppermost portions of the wellbore. The casing provides structural integrity to the newly drilled borehole.

Completion is the process of making a well ready for production or injection. This principally involves preparing a zone of the wellbore to the required specifications, running in the production tubing and associated downhole equipment, as well as perforating and stimulating as required.

Intervention is any operation carried out on a well during or at the end of its productive life that alters the state of the well or well geometry, provides well diagnostics, or manages the production of the well.

### Drilling and Drilling Fluids

A well is created by drilling a hole into the earth (or seabed) with a drilling rig that rotates a drill string with a drilling bit attached to the downward end. Usually the borehole is anywhere between about 5 inches (13 cm) to about 36 inches (91 cm) in diameter. As upper portions are cased or lined, progressively smaller drilling strings and bits must be used to pass through the uphole casings or liners, which steps the borehole down to progressively smaller diameters.

While drilling an oil or gas well, a drilling fluid is circulated downhole through a drillpipe to a drill bit at the downhole end, out through the drill bit into the wellbore, and then back uphole to the surface through the annular path between the tubular drillpipe and the borehole. The purpose of the drilling fluid is to maintain hydrostatic pressure in the wellbore, lubricate the drill string, and carry rock cuttings out from the wellbore.

The drilling fluid can be water-based or oil-based. Oil-based fluids tend to have better lubricating properties than water-based fluids, nevertheless, other factors can mitigate in favor of using a water-based drilling fluid. Such factors may include but not limited to presence of water-swellable formations, need for a thin but a strong and impermeable filtercake, temperature stability, corrosion resistance, stuck pipe prevention, contamination resistance and production protection.

### Completion and Completion Fluids

During completion or intervention, stimulation is a type of treatment performed to enhance or restore the productivity of oil and gas from a well. Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Other types of completion or intervention treatments can include, for example, gravel packing, consolidation, and controlling excessive water production.

### Fluid-Loss Control and Filtercake Formation

Fluid loss refers to the undesirable leakage of a fluid phase of any type of drilling, completion, or other treatment fluid into the permeable matrix of a subterranean formation. Fluids used in drilling, completion, or servicing of a wellbore can be lost to a subterranean formation while circulating the fluids in the wellbore. In particular, the fluids may enter the subterranean formation via depleted zones, zones of relatively low pressure, lost circulation zones having naturally occurring fractures, weak zones having fracture gradients exceeded by the hydrostatic pressure of the drilling fluid, and so forth. The extent of fluid losses to the formation may range from minor (for example less than 10 bbl/hr), which is referred to as seepage loss, to severe (for example, greater than 500 bbl/hr), which is referred to as complete loss. The greater the fluid loss, the more difficult it is to achieve the purpose of the fluid.

Fluid-loss control refers to treatments designed to reduce fluid loss. Providing effective fluid-loss control for fluids during certain stages of well operations is usually highly desirable.

The usual approach to fluid-loss control is to substantially reduce the permeability of the matrix of the zone with a fluid-loss control material that blocks the permeability at or near the face of the rock matrix of the zone. For example, the fluid-loss control material may be a particulate that has a size selected to bridge and plug the pore throats of the matrix. As the fluid phase carrying the fluid-loss control material leaks into the formation, the fluid-loss control material bridges the pore throats of the matrix of the formation and builds up on the surface of the borehole or fracture face or penetrates only a little into the matrix. All else being equal, the higher the concentration of the appropriately sized particulate, the faster bridging will occur. The buildup of solid particulate or other fluid-loss control material on the walls of a wellbore or a fracture is referred to as a filtercake. Such a filtercake can help block the further loss of a fluid phase (referred to as a filtrate) into the subterranean formation. A fluid-loss control material is specifically designed to lower the volume of a filtrate that passes through a filter medium. Accordingly, a fluid-loss control material is sometimes referred to as a filtration control agent.

Fluid-loss control fluids typically include an aqueous continuous phase and a high concentration of a viscosifying agent (usually crosslinked), and usually, bridging particles, such as graded sand, graded salt particulate, or graded calcium carbonate particulate. Through a combination of viscosity, solids bridging, and cake buildup on the porous rock of the borehole, such fluids are often able to substantially reduce the permeability of a zone of the subterranean formation to fluid loss.

For example, commonly used fluid-loss control pills contain high concentrations (100 to 150 lbs/1000 gal) of derivatized hydroxyethylcellulose (“HEC”). HEC is generally accepted as a viscosifying agent affording minimal permeability damage during completion operations. Normally, HEC polymer solutions do not form rigid gels, but control fluid loss by a viscosity-regulated or filtration mechanism. Some other viscosifying polymers that have been used include xanthan, guar, guar derivatives, carboxymethylhydroxyethylcellulose (“CMHEC”), and starch. Viscoelastic surfactants can also be used.

Crosslinked polymers can also be used for fluid-loss control. Crosslinking the gelling agent polymer helps suspend solids in a fluid as well as provide fluid-loss control. Further, crosslinked fluid-loss control pills have demonstrated that they require relatively limited invasion of the formation face to be fully effective. To crosslink the viscosifying polymers, a suitable crosslinking agent that includes polyvalent metal ions is used. Boron, aluminum, titanium, and zirconium are common examples.

A fluid-loss control pill is a treatment fluid that is designed or used to provide some degree of fluid-loss control. A fluid-loss control pill is usually used prior to introducing another drilling fluid or treatment fluid into zone. In addition, fluid-loss control materials are sometimes used in drilling fluids, various types of completion fluids, or various types of treatment fluids used in intervention.

### Filtercake Degradation

After a filtercake is formed, which can occur during drilling or various completion operations, it is usually desirable to restore the permeability of a zone for production from the zone. If the formation permeability of the desired producing zone is not restored, production levels from the formation can be significantly lower. Any filtercake or any solid or polymer filtration into the matrix of the zone resulting from a fluid-loss control treatment must be degraded to restore the formation's permeability, preferably to at least its original level. This is often referred to as clean up. In many cases, the filtercake adheres strongly to the borehole penetrating the formation, which makes clean up a difficult process.

Chemicals used to help degrade or remove a filtercake are called breakers.

Breakers for helping to degrade or remove a filtercake must be selected to meet the needs of each situation. First, it is important to understand the general performance criteria for degrading or breaking of a filtercake. Premature degradation of a filtercake can cause undesired fluid loss into a formation. Inadequate degradation of a filtercake can result in permanent damage to formation permeability. A breaker for degrading or removing a filtercake should be selected based on its performance in the temperature, pH, time, and desired filtercake profile for each specific fluid-loss application.

The term “degrade,” as used herein, refers to at least a partial degradation of a material in the filtercake. No particular mechanism is necessarily implied by degrading or breaking regarding a filtercake. A filtercake can be degraded or removed, for example, by dissolving the bridging particulate, chemically degrading or hydrolyzing a viscosity-increasing agent in the filtercake, reversing or degrading crosslinking if the viscosity-increasing agent is crosslinked, or any combination of these. More particularly, for example, a fluid-loss control agent can be selected for being insoluble in water but soluble in acid, whereby changing the pH or washing with an acidic fluid can dissolve a fluid-loss control agent or hydrolyze a viscosity-increasing agent in the filtercake.

Chemical breakers used to help clean up a filtercake or break the viscosity of a viscosified fluid are generally grouped into several classes: oxidizers, enzymes, chelating agents, and acids.

A filtercake usually includes sized carbonate or other acid-soluble particulate and an acid-degradable polymeric material.

### Acidizing

The purpose of acidizing in a well is to dissolve acid-soluble materials. For example, this can help degrade or remove residual fluid material or filtercake damage or to increase the permeability of a treatment zone.

The use of the term “acidizing” herein refers to the general process of introducing an acid down hole to perform a desired function, e.g., to acidize a portion of a wellbore to degrade or remove a filtercake.

Conventional acidizing fluids can include one or more of a variety of acids, such as hydrochloric acid, acetic acid, formic acid, hydrofluoric acid, or any combination of such acids.

Problems with Using Conventional Acids to Degrade a Filtercake

A major problem associated with conventional acidizing treatment systems to degrade or remove a filtercake, especially with strong acids at high concentrations, is that uniform treatment of an interval of a wellbore for degrading a filtercake is often not achievable because, among other things, the acid may be spent uphole before it can reach the downhole end of the interval. The aggressive nature of strong acid treatments can lead to cake dissolution uphole, which then leaks the acidizing treatment fluid into the formation instead of treating filtercake further downhole.

The rate at which acidizing fluids react with reactive materials in a filtercake is a function of various factors including, but not limited to, acid strength, acid concentration, temperature, fluid velocity, mass transfer, and the type of reactive material encountered. To achieve optimal results, it is desirable to maintain the acidic solution in a reactive condition for as long a period as possible to maximize the uniformity of the treatment of a filtercake along an interval of a wellbore.

Another problem with using strongly acidic solutions is that they tend to be more corrosive to metals than weakly acidic solutions.

Yet another problem associated with acidic well fluids is that the acids or the well fluids can pose handling or safety concerns due to the reactivity of the acid. For instance, during a conventional acidizing operation, corrosive fumes may be released from the acid as it is injected down the well bore. The fumes can cause an irritation hazard to nearby personnel, and a corrosive hazard to surface equipment used to carry out the operation.

Moreover, handling of even weak acids in concentrated solutions can present environmental concerns. Due to stricter environmental regulations, the use of large quantities of acids will become difficult in future.

Therefore, among other needs, there is a need for alternative treatment fluids and methods for filtercake clean up. There exists a continuing need for breaker fluids that effectively degrade or remove the mud filtercake and do not inhibit the ability of the formation to produce oil or gas once the well is brought into production. In addition, due to growing environmental concerns, there is a need to come up with newer technologies, which can reduce the use of chemicals being pumped downhole. Further, preparation of bacteria-nutrient mixtures is a well-established commercial process utilizing low cost raw materials, and is widely used in many industry segments for various purposes. Hence, the present invention has the potential to be a cost effective and commercially viable technology.

### SUMMARY OF THE INVENTION

The purpose of this invention is to provide a method of degradation of a filtercake in a wellbore using acid-producing microorganisms.

A method of degrading a filtercake in an interval of a wellbore penetrating a subterranean formation is provided. The filtercake comprises a gelled or solid material that can be dissolved or hydrolyzed with an acidic fluid. The method includes the steps of: (A) introducing a treatment fluid into the interval of the wellbore, the treatment fluid comprising: (i) water; and (ii) an acid-producing anaerobic microorganism; and then (B) shutting in the interval of the wellbore.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the scope of the invention as expressed in the appended claims.

### DETAILED DESCRIPTION OF PRESENTLY PREFERRED EMBODIMENTS AND BEST MODE

### Definitions and Usages

General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Terms such as “first,” “second,” “third,” etc. may be assigned arbitrarily and may be merely intended to differentiate between two or more components, parts, or steps that are otherwise similar or corresponding in nature, structure, function, or action. For example, the words “first” and “second” serve no other purpose and may not be part of the name or description of the following name or descriptive terms. The mere use of the term “first” does not require that there be any “second” similar or corresponding component, part, or step. Similarly, the mere use of the word “second” does not require that there be any “first” or “third” similar or corresponding component, part, or step. Further, it is to be understood that the mere use of the term “first” does not require that the element or step be the very first in any sequence, but merely that it is at least one of the elements or steps. Similarly, the mere use of the terms “first” and “second” does not necessarily require any sequence. Accordingly, the mere use of such terms does not exclude intervening elements or steps between the “first” and “second” elements or steps, etc.

The control or controlling of a condition includes any one or more of maintaining, applying, or varying of the condition. For example, controlling the temperature of a substance can include heating, cooling, or thermally insulating the substance.

Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Well Terms

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, the word “tubular” means any kind of body in the general form of a tube. Examples of tubulars include, but are not limited to, a drill pipe, a casing, a tubing string, a line pipe, and a transportation pipe. Tubulars can also be used to transport fluids such as oil, gas, water, liquefied methane, coolants, and heated fluids into or out of a subterranean formation.

As used herein, a “well fluid” broadly refers to any fluid adapted to be introduced into a well for any purpose. A well fluid can be, for example, a drilling fluid, a setting composition, a treatment fluid, or a spacer fluid. If a well fluid is to be used in a relatively small volume, for example less than about 200 barrels (about 8,400 US gallons or about 32 m³), it is sometimes referred to as a wash, dump, slug, or pill.

As used herein, introducing “into a well” means introducing at least into and through the wellhead. According to various techniques known in the art, tubulars, equipment, tools, or well fluids can be directed from the wellhead into any desired portion of the wellbore.

Drilling fluids, also known as drilling muds or simply “muds,” are typically classified according to their base fluid, that is, the nature of the continuous phase. A water-based mud (“WBM”) has a water phase as the continuous phase. The water can be brine. A brine-based drilling fluid is a water-based mud in which the aqueous component is brine. In some cases, oil may be emulsified in a water-based drilling mud. An oil-based mud (“OBM”) has an oil phase as the continuous phase. In some cases, a water phase is emulsified in the oil-based mud.

As used herein, the word “treatment” refers to any treatment for changing a condition of a portion of a wellbore or a subterranean formation adjacent a wellbore; however, the word “treatment” does not necessarily imply any particular treatment purpose. A treatment usually involves introducing a well fluid for the treatment, in which case it may be referred to as a treatment fluid, into a well.

As used herein, a “treatment fluid” is a fluid used in a treatment. The word “treatment” in the term “treatment fluid” does not necessarily imply any particular treatment or action by the fluid.

As used herein, the terms spacer fluid, wash fluid, and inverter fluid can be used interchangeably. A spacer fluid is a fluid used to physically separate one special-purpose fluid from another. It may be undesirable for one special-purpose fluid to mix with another used in the well, so a spacer fluid compatible with each is used between the two. A spacer fluid is usually used when changing between well fluids used in a well.

In the context of a well or wellbore, a “portion” or “interval” refers to any downhole portion or interval of the length of a wellbore.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

As used herein, a “downhole fluid” is an in-situ fluid in a well, which may be the same as a well fluid at the time it is introduced, or a well fluid mixed with another other fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the well fluid on the BHST during treatment. The design temperature for a well fluid is sometimes referred to as the bottom hole circulation temperature (“BHCT”). Because well fluids may be considerably cooler than BHST, the difference between the two temperatures can be quite large. Ultimately, if left undisturbed, a subterranean formation will return to the BHST.

The term “damage” as used herein regarding a formation refers to undesirable deposits in a subterranean formation that may reduce its permeability. Scale, skin, gel residue, and hydrates are contemplated by this term.

Substances, Chemicals, Polymers, and Derivatives

A substance can be a pure chemical or a mixture of two or more different chemicals.

As used herein, a “polymer” or “polymeric material” includes polymers, copolymers, terpolymers, etc. In addition, the term “copolymer” as used herein is not limited to the combination of polymers having only two monomeric units, but includes any combination of monomeric units, e.g., terpolymers, tetrapolymers, etc.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

Physical States and Phases

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand. As used herein, however, unless the context otherwise requires, particulate refers to a solid particulate.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to intermolecular forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of intermolecular forces.)

Every fluid inherently has at least a continuous phase. A fluid can have more than one phase. The continuous phase of a well fluid is a liquid under Standard Laboratory Conditions. For example, a well fluid can be in the form of a suspension (larger solid particles dispersed in a liquid phase), a sol (smaller solid particles dispersed in a liquid phase), an emulsion (liquid particles dispersed in another liquid phase), or a foam (a gas phase dispersed in a liquid phase).

As used herein, a water-based fluid means that water or an aqueous solution is the dominant material of the continuous phase, that is, greater than 50% by weight, of the continuous phase of the fluid based on the combined weight of water and any other solvents in the phase (that is, excluding the weight of any dissolved solids).

In contrast, “oil-based” means that oil is the dominant material by weight of the continuous phase of the fluid. In this context, the oil of an oil-based fluid can be any oil.

In the context of a well fluid, “oil” is understood to refer to an oil liquid, whereas gas is understood to refer to a physical state of a substance, in contrast to a liquid. In this context, “oil” is any substance that is liquid under Standard Laboratory Conditions, is hydrophobic, and soluble in organic solvents. Oils have a high carbon and hydrogen content and are non-polar substances. This general definition includes classes such as petrochemical oils, vegetable oils, and many organic solvents. All oils can be traced back to organic sources.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

Most well fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of centipoise (“cP”).

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel. A “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

As used herein, a substance referred to as a “gel” is subsumed by the concept of “fluid” if it is a pumpable fluid.

A substance is considered to be a fluid if it has an apparent viscosity less than 5,000 cP (independent of any gel characteristic). For reference, the viscosity of pure water is about 1 cP.

### General Objectives

After a filtercake is formed, it may be desirable to restore permeability into the formation. If the formation permeability of the desired producing zone is not restored, production levels from the formation can be significantly lower. Any filtercake or any solid or polymer filtration into the matrix of the zone resulting from a fluid-loss control treatment must be degraded or removed to restore the formation's permeability, preferably to at least its original level. This is often referred to as “clean up.”

Although various types of acidic breaker fluids are commonly used for filtercake clean up, it is often desirable to allow for a delay in acid generation to give sufficient time for the treatment fluid to be placed across a treatment interval. After placing the treatment fluid, the well is shut in for a sufficient time to initiate degrading of the filtercake and to enable efficient and complete clean up.

In general, the present invention provides compositions and methods for degrading of one or more types of acid-sensitive materials that may be in filtercakes. In certain embodiments, the methods of the present invention degrade at least a portion of the fluid-loss additive component of a filtercake in a subterranean formation. In certain embodiments, the methods of the present invention also may comprise degradation of bridging agents from a filter cake in a subterranean formation. In certain exemplary embodiments, the methods of the present invention compromise the integrity of the filtercake to a degree at least sufficient to allow any pressure differential between formation fluids and the well bore to induce flow from the formation.

A composition according to the present invention for degrading a filtercake in a wellbore comprises an acid-producing anaerobic microorganism.

In an embodiment, the invention provides a method of degrading a filtercake in a wellbore using an acid-producing microorganism. By injecting mixtures of acid-producing bacteria, degrading or removal of acid-soluble material comprising the filtercake can be initiated. According to the invention, degrading a filtercake in a wellbore is achieved by introducing an acid-producing microorganism into the wellbore, preferably after a step of forming a filtercake, e.g., by drilling with a drilling mud. The acid-producing microorganism releases one or more weak acids, which can react with the carbonate in the filtercake to degrade the filtercake. However, because the acid is generated slowly, the treatment fluid can treat an interval of the wellbore more uniformly because the acid is generated in-situ.

In another embodiment, methods of drilling or completing an openhole well are provided. The methods can include the following steps of: (A) drilling with an oil-based drilling fluid to form a borehole of a wellbore penetrating a subterranean formation, wherein a filtercake in an oil-wet condition is formed on the borehole of the wellbore; and then (B) introducing a first treatment fluid into the wellbore wherein the first treatment fluid comprises a surfactant to change the filtercake to be water wet; and then (C) introducing a second treatment fluid into the wellbore, the second treatment fluid comprising: (i) water; and (ii) an acid-producing anaerobic microorganism; and then (D) shutting in the interval of the wellbore.

It is believed that the average generation time for bacteria is 30-60 minutes. However, some species of bacteria are known to double in every 20-30 minutes. By controlling the nutrition supplied to the microorganisms, the growth and metabolism of microorganisms can be regulated. This can, in turn, control or delay the release of acid produced by a microorganism. For example, the compositions with the acid-producing microorganism can be designed to have a delayed effect on a portion of a filtercake in a wellbore, for instance, when the process will involve a long pump time.

This invention using an acid-producing microorganism provides an environmentally acceptable technology in the oilfield industry for degrading a filtercake containing a material that can be dissolved or hydrolyzed with an acidic solution.

### Acid-Producing Microorganisms and Extremophiles

Limestone is a sedimentary rock, comprising of calcium carbonate, which forms in warm, shallow marine waters. The rock can form as a result of the accumulation of shell, coral, algal, or fecal debris, as well as calcium carbonate precipitation from lake and ocean waters.

Over time, the permeable and soluble limestone can be eroded by the action of water. For example, the weak carbonic acid from rainwater can react with the limestone rock, dissolve it, and erode it away. The dissolution and erosion of the limestone gives rise to what we call, “limestone caves.” In the oilfield industry, the commonly referred term “carbonate formations” are essentially limestone or dolomite formations that have not been eroded away by action of water.

Geochemical rates of mineral dissolution and deposition are dependent on groundwater acidity and CO₂ partial pressures. Mineral dissolution can also result from the action of very acidic sediment fluids that are under saturated with carbonate minerals. The source of the acids and elevated CO₂ pressures is attributable to the action of microbial metabolism in biofilms associated with limestone surfaces and interclastic spaces between particles of sediment.

A “microbe” or “microorganism” is an organism that is microscopic or submicroscopic, which means it is too small to be seen by the unaided human eye. Microorganisms were first observed by Anton van Leeuwenhoek in 1675 using a microscope of his own design. A microbe is a microscopic organism that comprises a single cell (unicellular), cell clusters, or multicellular relatively complex organisms. Microorganisms are very diverse and they include bacteria, fungi, algae, and protozoa. Although microscopic, viruses and prions are not considered microorganisms because they are generally regarded as non-living.

The word “microbial” is derived from microbe. For example, microbial degradation implies degradation by a microbe.

Bacteria are a large domain of prokaryotic microorganisms. Bacteria are typically a few micrometers in length and have a wide range of shapes, ranging from spheres to rods and spirals. Bacteria are present in most habitats on Earth, growing in soil, acidic hot springs, radioactive waste, water, deep in the Earth's crust, as well as in organic matter.

Experiments conducted by Fowler et al demonstrate the dissolution of calcite (Iceland spar) by bacteria isolated from the cave sediments. Many bacteria, especially members of the family Enterobacteriaceae, carry out mixed acid fermentation, which results in the excretion of complex mixture of acids and the production of carbon dioxide. Calcite dissolution kinetics were presumed to be limited by diffusional transport through the mineral/fluid surface boundary layer.

Mixed acid fermentation is an anaerobic fermentation where the products are a complex mixture of acids, particularly lactate, acetate, succinate and formate as well as ethanol and equal amounts of H₂ and CO₂. It is characteristic for members of the Enterobacteriaceae family. M. Madigan & J. Martinko, 11th edition, (2006) Brock's Biology of Microorganisms, NJ, Pearson Prentice Hall, p. 352.

The acid-producing microorganisms typically produce lactic acid, formic acid, acetic acid, propionic acid, etc. The pH that is expected due to acid liberation from the microorganisms is in the range of about 2 to about 4. This is sufficiently acidic to react with calcium or magnesium carbonate so that it can be dissolved.

This acidic pH does not kill the microorganisms as the acid-producing microorganism maintains its internal pH close to neutral and hence maintains a large chemical proton gradient across the cell membrane. However, even with this large chemical proton gradient, the movement of proton inside the cell is minimized by an intra-cellular net positive charge.

There has been evidence to support the presence and growth of bacteria at reservoir temperatures and pressures, such as extremophiles, including thermophiles and barophiles.

Extremophiles are organisms that live in “extreme” environments. The name, first used in 1974 in a paper by a scientist named R. D. MacElroy, literally means extreme loving. These hardy creatures are remarkable not only because of the environments in which they live, but also because some types could not survive in supposedly normal, moderate environments.

Many extreme environments, such as acidic or hot springs, saline and/or alkaline lakes, deserts and the ocean beds are also found in nature, which are too harsh for normal life to exist. Any environmental condition that can be perceived as beyond the normal acceptable range is an extreme condition. Varieties of microbes, however, survive and grow in such environments. These organisms, known as extremophiles, not only tolerate specific extreme conditions, but also usually require these for survival and growth. Most extremophiles are found in microbial world. The range of environmental extremes tolerated by microbes is much broader than other life forms. The limits of growth and reproduction of microbes are, from about minus 12° C. (10° F.) to more than 100° C. (212° F.), pH in the range of 0 to 13, hydrostatic pressures up to 1.4×10⁷ kg/m² (1400 atm or 21, psi), and salt concentrations up to saturated brines. T. Satyanarayana, Chandralata Raghukumar, and S. Shivaji, Extremophilic microbes: Diversity and perspectives, Current Science, Vol. 89, No. 1, July 2005, pp. 78-90.

Thermophiles are a type of microorganism that can survive at high temperatures. For example, some thermophile bacteria can live in a temperature range from −12° C. (10° F.) to +100° C. (212° F.). The latest knowledge gathered on these thermophiles reveals that some thermophiles can survive at up to 121° C. (249.8° F.). The thermophile bacteria have a tendency to multiply, approximately 2 fold to 3 fold within a few hours to a few days when exposed to a suitable environment (temperature and a nutrition medium).

Barophiles are a type of microorganism that can survive under great pressures. They live deep under the surfaces of the earth or water. There are three kinds of these microorganisms: barotolerant, barophilic, and extreme barophiles. Barotolerant extremophiles can survive at up to 400 atmospheres (4×10⁶ kg/m²) below the water or earth, but grow best in 1 atmosphere (1×10⁴ kg/m²). Barophilic extremophiles grow best at higher pressures in the range of about 500 to 600 atmospheres (5.2×10⁶ to 6.2×10⁶ kg/m²). Extreme barophiles do best at 700 atmosphere (7.2×10⁶ kg/m²) or more, but some survive at 1 atmosphere (1×10⁴ kg/m²).

While microbial techniques have been used in enhanced oil recovery, it has never been recognized that the techniques could be applied to acidizing for degrading or removal of a filtercake.

The present invention discloses a novel approach to break a filtercake in a wellbore using acid-producing microorganisms, based on the evidences of limestone dissolution occurring in limestone caves. By injecting an acid-producing microorganism into the wellbore, degrading of a filtercake can be achieved. The release of acid by the microorganism colonies can be used to react with and dissolve carbonate materials or to hydrolyze polymeric material in the filtercake that may be subject to acid hydrolysis.

Many subterranean formations fall within a temperature and pressure range in which thermophiles and barophiles can live. Some thermophiles and barophiles are acid producing. Hence, the type of bacteria, initial concentration of the microorganism, and the nutrition to be used, can be adjusted depending on the amount of acid desired to be produced in situ in a formation.

Examples of such extremophiles that are expected to be useful microorganisms according to the invention include Enterobacteriaceae, Escherichia coli, Serratia marcescens, Pseudomonas putida, Klebsiella pneumoniae, and any combination thereof. An example of Enterobacteriaceae is Enterobacter Cloacae.

### Nutrition and Respiration

Microorganisms require a suitable source of nutrition. A sugar, such as molasses, is one nutrient option. Thioglycollate broth is another example. Preparation of bacteria-nutrient mixtures is a well-established commercial process utilizing low cost raw materials, and is widely used in other industries and applications. Hence, the present invention has the potential to be a cost effective and commercially viable technology.

In addition, it is contemplated that a water-soluble polysaccharide can be a source of nutrition for an acid-producing microorganism. The microorganism may be able to use the polysaccharide as a direct source of nutrition. Optionally, subject to temperature stability, an enzyme for the polysaccharide can be included that breaks the polysaccharide into sugar molecules. This can serve a dual purpose of degrading or breaking the viscosity of a well fluid that is viscosified with a polysaccharide as well as providing at least some of a nutrition source for the acid-producing microorganism.

Anaerobic respiration is a form of respiration using electron acceptors other than oxygen. Although oxygen is not used as the final electron acceptor, the process still uses a respiratory electron transport chain; it is respiration without oxygen. In order for the electron transport chain to function, an exogenous final electron acceptor must be present to allow electrons to pass through the system. In aerobic organisms, this final electron acceptor is oxygen. Molecular oxygen is a highly oxidizing agent and, therefore, is an excellent acceptor. In anaerobes, other less-oxidizing substances such as sulfate (SO₄²⁻), nitrate (NO₃⁻), or sulfur (S) are used. These terminal electron acceptors have smaller reduction potentials than O₂, meaning that less energy is released per oxidized molecule. Anaerobic respiration is, therefore, in general energetically less efficient than aerobic respiration.

### Filtercake Treatment Interval

A filtercake treatment interval can be selected on the basis of any one or more of at least the following criteria: carbonate composition, permeability, design or static temperature, pressure, and design or static pressure.

Preferably, the methods are used to treat a filtercake that comprises at least 50% by weight of one or more alkaline earth carbonates.

Preferably, the methods are used to treat a filtercake treatment interval that has a bottom hole static temperature in the range of 60° C. (140° F.) to 121° C. (250° F.). More preferably, the treatment zone has a bottom hole static temperature in the range of 60° C. (140° F.) to 100° C. (212° F.).

Preferably, the methods are used to treat a filtercake treatment interval that has a static pressure in the range of 7×10⁴ kg/m² (100 psi) to 1×10⁶ kg/m² (2,200 psi).

For example, in an embodiment the filtercake treatment interval can have the following characteristics: comprise at least 50% of one or more alkaline earth carbonates; and have a bottom hole static temperature anywhere in the range of 60° C. to 121° C.

Preferably, the methods include a step of selecting the filtercake treatment interval and the microorganism to be compatible for the survival of the microorganism.

Preferably, extremophiles of such acid-producing microorganisms can be selected that can live in subterranean formations, for example, up to 100° C. (212° F.) and a pressure up to about 1.4×10⁷ kg/m² (1,400 atmospheres or 21,000 psi).

Well Fluid with Acid-Producing Microorganism

In general, the one or more treatment fluids for use in the steps of the methods according to the invention are preferably water-based.

Preferably, the water for use in a well fluid does not contain anything that would adversely interact with the other components used in the well fluid or with the subterranean formation.

The aqueous phase can include freshwater or non-freshwater. Non-freshwater sources of water can include surface water ranging from brackish water to seawater, brine, returned water (sometimes referred to as flowback water) from the delivery of a well fluid into a well, unused well fluid, and produced water. As used herein, brine refers to water having at least 40,000 mg/L total dissolved solids.

In some embodiments, the aqueous phase of the treatment fluid may comprise a brine. The brine chosen should be compatible with the formation and should have a sufficient density to provide the appropriate degree of well control.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Suitable salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The amount of salt that should be added should be the amount necessary for formation compatibility, such as stability of clay minerals, taking into consideration the crystallization temperature of the brine, e.g., the temperature at which the salt precipitates from the brine as the temperature drops.

A well fluid can contain additives that are commonly used in oil field applications, as known to those skilled in the art. These include, but are not necessarily limited to, brines, inorganic water-soluble salts, salt substitutes (such as trimethyl ammonium chloride), pH control additives, surfactants, breakers, breaker aids, oxygen scavengers, alcohols, scale inhibitors, corrosion inhibitors, hydrate inhibitors, fluid-loss control additives, oxidizers, chelating agents, water control agents (such as relative permeability modifiers), consolidating agents, proppant flowback control agents, conductivity enhancing agents, clay stabilizers, sulfide scavengers, fibers, nanoparticles, and combinations thereof.

Of course, additives should be selected for not interfering with the purpose of the well fluid.

Optional Acidizing Filtercake with Bronsted-Lowry Acid

Optionally, the use of acid-producing microorganism can be combined with using a conventional acid for acidizing of a filtercake in a wellbore. As discussed above, the microorganism can be tolerant to acidic conditions. Accordingly, it is optional to use both one or more acids to initiate acidizing a filtercake. The acid-producing microorganism can generate additional acid in-situ, supplementing the effectiveness of the treatment with acid-producing microorganisms or vice-versa.

The pH value represents the acidity of a solution. The potential of hydrogen (pH) is defined as the negative logarithm to the base 10 of the hydrogen concentration, represented as [H⁺] in moles/liter.

Mineral acids tend to dissociate in water more easily than organic acids, to produce H⁺ ions and decrease the pH of the solution. Organic acids tend to dissociate more slowly than mineral acids and less completely.

Relative acid strengths for Bronsted-Lowry acids are expressed by the dissociation constant (pKa). A given acid will give up its proton to the base of an acid with a higher pKa value. The bases of a given acid will deprotonate an acid with a lower pKa value. In case there is more than one acid functionality for a chemical, “pKa(1)” makes it clear that the dissociation constant relates to the first dissociation.

Water (H₂O) is the base of the hydronium ion, H₃O⁺, which has a pKa −1.74. An acid having a pKa less than that of hydronium ion, pKa −1.74, is considered a strong acid.

Optionally, a treatment fluid for use in the methods comprises one or more water-soluble acids having a pKa(1) in water of less than 10 and that are in sufficient concentration such that the water has a pH less than 5. Such a treatment fluid is sometimes referred to herein as an acidizing fluid. More preferably, the acidizing fluid comprises one or more acids having a pKa(1) in water of less than 5. Still more preferably, the one or more acids in the acidizing fluid are in a sufficient concentration such that the water has a pH less than 4. Most preferably, the treatment fluid comprises one or more strong acids such that the pH is less than 2. For example, it is contemplated that the treatment fluid can be up to 7% w/w HCl.

For example, hydrochloric acid (HCl) has pKa −7, which is greater than the pKa of the hydronium ion, pKa −1.74. This means that HCl will give up its protons to water essentially completely to form the H₃O⁺ cation. For this reason, HCl is classified as a strong acid in water. One can assume that all of the HCl in a water solution is 100% dissociated, meaning that both the hydronium ion concentration and the chloride ion concentration correspond directly to the concentration of added HCl.

### Optional Inclusion of Corrosion Inhibitor

Optionally, a treatment fluid that is acidic or becomes acidic in-situ, especially an acidizing fluid with a conventional acid, additionally comprises a corrosion inhibitor that does not interfere with the acid-producing microorganism.

Corrosion of metals can occur anywhere in an oil or gas production system, such in the downhole tubulars, equipment, and tools of a well, in surface lines and equipment, or transportation pipelines and equipment.

“Corrosion” is the loss of metal due to chemical or electrochemical reactions, which could eventually destroy a structure. The corrosion rate will vary with time depending on the particular conditions to which a metal is exposed, such as the amount of water, pH, other chemicals, temperature, and pressure. Examples of common types of corrosion include, but are not limited to, the rusting of metal, the dissolution of a metal in an acidic solution, oxidation of a metal, chemical attack of a metal, electrochemical attack of a metal, and patina development on the surface of a metal.

Even weakly acidic fluids having a pH between 4 to 6 can be problematic in that they can cause corrosion of metals. As used herein with reference to the problem of corrosion, “acid” or “acidity” refers to a Bronsted-Lowry acid or acidity.

As used herein, the term “inhibit” or “inhibitor” refers to slowing down or lessening the tendency of a phenomenon (e.g., corrosion) to occur or the degree to which that phenomenon occurs. The term “inhibit” or “inhibitor” does not imply any particular mechanism, or degree of inhibition.

A “corrosion inhibitor package” can include one or more different chemical corrosion inhibitors, sometimes delivered to the well site in one or more solvents to improve flowability or handleability of the corrosion inhibitor before forming a well fluid.

When included, a corrosion inhibitor is preferably in a concentration of at least 0.1% by weight of a fluid. More preferably, the corrosion inhibitor is in a concentration in the range of 0.1% to 15% by weight of the fluid.

An example of a corrosion inhibitor package contains an aldehyde (i.e., cinnamaldehyde), methanol, isopropanol, and a quaternary ammonium salt (e.g., 1-(benzyl)quinolinium chloride).

A corrosion inhibitor “intensifier” is a chemical compound that itself does not inhibit corrosion, but enhances the effectiveness of a corrosion inhibitor over the effectiveness of the corrosion inhibitor without the corrosion inhibitor intensifier. A corrosion inhibitor intensifier can be selected from the group consisting of: formic acid, potassium iodide, and any combination thereof.

When included, a corrosion inhibitor intensifier is preferably in a concentration of at least 0.1% by weight of the fluid. More preferably, the corrosion inhibitor intensifier is in a concentration in the range of 0.1% to 20% by weight of the fluid.

### Optional Viscosity-Increasing Agent

Increasing the viscosity of a well fluid can help prevent a particulate having a different specific gravity than a surrounding phase of the fluid from quickly separating out of the fluid.

A viscosity-increasing agent can be used to increase the ability of a fluid to suspend and carry a particulate material in a well fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

Polymers for Increasing Viscosity

Certain kinds of polymers can be used to increase the viscosity of a fluid. In general, the purpose of using a polymer is to increase the ability of the fluid to suspend and carry a particulate material. Polymers for increasing the viscosity of a fluid are preferably soluble in the external phase of a fluid. Polymers for increasing the viscosity of a fluid can be naturally occurring polymers such as polysaccharides, derivatives of naturally occurring polymers, or synthetic polymers.

Well fluids used in high volumes, such as fracturing fluids, are usually water-based. Efficient and inexpensive viscosity-increasing agents for water include certain classes of water-soluble polymers.

As will be appreciated by a person of skill in the art, the dispersibility or solubility in water of a certain kind of polymeric material may be dependent on the salinity or pH of the water. Accordingly, the salinity or pH of the water can be modified to facilitate the dispersibility or solubility of the water-soluble polymer. In some cases, the water-soluble polymer can be mixed with a surfactant to facilitate its dispersibility or solubility in the water or salt solution utilized.

The water-soluble polymer can have an average molecular weight in the range of from about 50,000 to 20,000,000, most preferably from about 100,000 to about 4,000,000. For example, guar polymer is believed to have a molecular weight in the range of about 2 to about 4 million.

Typical water-soluble polymers used in well treatments include water-soluble polysaccharides and water-soluble synthetic polymers (e.g., polyacrylamide). The most common water-soluble polysaccharides employed in well treatments are guar and its derivatives.

As used herein, a “polysaccharide” can broadly include a modified or derivative polysaccharide.

A polymer can be classified as being single chain or multi chain, based on its solution structure in aqueous liquid media. Examples of single-chain polysaccharides that are commonly used in the oilfield industry include guar, guar derivatives, and cellulose derivatives. Guar polymer, which is derived from the beans of a guar plant, is referred to chemically as a galactomannan gum. Examples of multi-chain polysaccharides include xanthan, diutan, and scleroglucan, and derivatives of any of these. Without being limited by any theory, it is currently believed that the multi-chain polysaccharides have a solution structure similar to a helix or are otherwise intertwined.

The viscosity-increasing agent can be provided in any form that is suitable for the particular well fluid or application. For example, the viscosity-increasing agent can be provided as a liquid, gel, suspension, or solid additive that incorporated into a well fluid.

If used, a viscosity-increasing agent may be present in the well fluids in a concentration in the range of from about 0.01% to about 5% by weight of the continuous phase therein.

Crosslinking of Polymer to Increase Viscosity of a Fluid or Form a Gel

The viscosity of a fluid at a given concentration of viscosity-increasing agent can be greatly increased by crosslinking the viscosity-increasing agent. A crosslinking agent, sometimes referred to as a crosslinker, can be used for this purpose. A crosslinker interacts with at least two polymer molecules to form a “crosslink” between them.

If crosslinked to a sufficient extent, the polysaccharide may form a gel with water. Gel formation is based on a number of factors including the particular polymer and concentration thereof, the particular crosslinker and concentration thereof, the degree of crosslinking, temperature, and a variety of other factors known to those of ordinary skill in the art.

For example, one of the most common viscosity-increasing agents used in the oil and gas industry is guar. A mixture of guar dissolved in water forms a base gel, and a suitable crosslinking agent can be added to form a much more viscous fluid, which is then called a crosslinked fluid. The viscosity of base gels of guar is typically about 20 to about 50 cp. When a base gel is crosslinked, the viscosity is increased by 2 to 100 times depending on the temperature, the type of viscosity testing equipment and method, and the type of crosslinker used.

The degree of crosslinking depends on the type of viscosity-increasing polymer used, the type of crosslinker, concentrations, temperature of the fluid, etc. Shear is usually required to mix the base gel and the crosslinking agent. Thus, the actual number of crosslinks that are possible and that actually form also depends on the shear level of the system. The exact number of crosslink sites is not well known, but it could be as few as one to about ten per polymer molecule. The number of crosslinks is believed to significantly alter fluid viscosity.

For a polymeric viscosity-increasing agent, any crosslinking agent that is suitable for crosslinking the chosen monomers or polymers may be used.

Cross-linking agents typically comprise at least one metal ion that is capable of cross-linking the viscosity-increasing agent molecules.

Some crosslinking agents form substantially permanent crosslinks with viscosity-increasing polymer molecules. Such crosslinking agents include, for example, crosslinking agents of at least one metal ion that is capable of crosslinking gelling agent polymer molecules. Examples of such crosslinking agents include, but are not limited to, zirconium compounds (such as, for example, zirconium lactate, zirconium lactate triethanolamine, zirconium carbonate, zirconium acetylacetonate, zirconium maleate, zirconium citrate, zirconium oxychloride, and zirconium diisopropylamine lactate); titanium compounds (such as, for example, titanium lactate, titanium maleate, titanium citrate, titanium ammonium lactate, titanium triethanolamine, and titanium acetylacetonate); aluminum compounds (such as, for example, aluminum acetate, aluminum lactate, or aluminum citrate); antimony compounds; chromium compounds; iron compounds (such as, for example, iron chloride); copper compounds; zinc compounds; sodium aluminate; or a combination thereof.

Crosslinking agents can include a crosslinking agent composition that may produce delayed crosslinking of an aqueous solution of a crosslinkable organic polymer, as described in U.S. Pat. No. 4,797,216, the entire disclosure of which is incorporated herein by reference. Crosslinking agents can include a crosslinking agent composition that may include a zirconium compound having a valence of +4, an alpha-hydroxy acid, and an amine compound as described in U.S. Pat. No. 4,460,751, the entire disclosure of which is incorporated herein by reference.

Some crosslinking agents do not form substantially permanent crosslinks, but rather chemically labile crosslinks with viscosity-increasing polymer molecules. For example, a guar-based gelling agent that has been crosslinked with a borate-based crosslinking agent does not form permanent cross-links.

Where present, the cross-linking agent generally should be included in the fluids in an amount sufficient, among other things, to provide the desired degree of cross linking. In some embodiments, the cross-linking agent may be present in the treatment fluids in an amount in the range of from about 0.01% to about 5% by weight of the treatment fluid.

Buffering compounds may be used if desired, e.g., to delay or control the cross linking reaction. These may include glycolic acid, carbonates, bicarbonates, acetates, phosphates, and any other suitable buffering agent.

Sometimes, however, crosslinking is undesirable, as it may cause the polymeric material to be more difficult to break and it may leave an undesirable residue in the formation.

Viscosifying Surfactants (i.e. Viscoelastic Surfactants)

It should be understood that merely increasing the viscosity of a fluid may only slow the settling or separation of distinct phases and does not necessarily stabilize the suspension of any particles in the fluid.

Certain viscosity-increasing agents can also help suspend a particulate material by increasing the elastic modulus of the fluid. The elastic modulus is the measure of a substance's tendency to be deformed non-permanently when a force is applied to it. The elastic modulus of a fluid, commonly referred to as G′, is a mathematical expression and defined as the slope of a stress versus strain curve in the elastic deformation region. G′ is expressed in units of pressure, for example, Pa (Pascal) or dyne/cm². As a point of reference, the elastic modulus of water is negligible and considered to be zero.

An example of a viscosity-increasing agent that is also capable of increasing the suspending capacity of a fluid is to use a viscoelastic surfactant. As used herein, the term “viscoelastic surfactant” or “VES” refers to a surfactant that imparts or is capable of imparting viscoelastic behavior to a fluid due, at least in part, to the three-dimensional association of surfactant molecules to form viscosifying micelles. When the concentration of the viscoelastic surfactant in a viscoelastic fluid significantly exceeds a critical concentration, and in most cases in the presence of an electrolyte, surfactant molecules aggregate into species such as micelles, which can interact to form a network exhibiting elastic behavior.

As used herein, the term “micelle” is defined to include any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure.

These micelles may function, among other purposes, to stabilize emulsions, break emulsions, stabilize a foam, change the wettability of a surface, solubilize certain materials, or reduce surface tension. When used as a viscosity-increasing agent, the molecules (or ions) of the surfactants used associate to form micelles of a certain micellar structure (e.g., rodlike, wormlike, vesicles, etc., which are referred to herein as “viscosifying micelles”) that, under certain conditions (e.g., concentration, ionic strength of the fluid, etc.) are capable of, inter alia, imparting increased viscosity to a particular fluid or forming a gel. Certain viscosifying micelles may impart increased viscosity to a fluid such that the fluid exhibits viscoelastic behavior (e.g., shear thinning properties) due, at least in part, to the association of the surfactant molecules contained therein.

As used herein, the term “VES fluid” (or “surfactant gel”) refers to a fluid that exhibits or is capable of exhibiting viscoelastic behavior due, at least in part, to the association of surfactant molecules contained therein to form viscosifying micelles.

Viscoelastic surfactants may be cationic, anionic, or amphoteric in nature. The viscoelastic surfactants can include any number of different compounds, including ester sulfonates, hydrolyzed keratin, sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives thereof, and combinations thereof.

Examples of commercially-available viscoelastic surfactants include, but are not limited to, MIRATAINE BET-O 30™ (an oleamidopropyl betaine surfactant available from Rhodia Inc., Cranbury, N.J.), AROMOX APA-T™ (amine oxide surfactant available from Akzo Nobel Chemicals, Chicago, Ill.), ETHOQUAD O/12 PG™ (a fatty amine ethoxylate quat surfactant available from Akzo Nobel Chemicals, Chicago, Ill.), ETHOMEEN T/12™ (a fatty amine ethoxylate surfactant available from Akzo Nobel Chemicals, Chicago, Ill.), ETHOMEEN S/12™ (a fatty amine ethoxylate surfactant available from Akzo Nobel Chemicals, Chicago, Ill.), and REWOTERIC AM TEG™ (a tallow dihydroxyethyl betaine amphoteric surfactant available from Degussa Corp., Parsippany, N.J.). See, for example, U.S. Pat. No. 7,727,935 issued Jun. 1, 2010 having for named inventor Thomas D. Welton entitled “Dual-Function Additives for Enhancing Fluid Loss Control and Stabilizing Viscoelastic Surfactant Fluids,” which is incorporated herein by reference in the entirety.

### Optional Changing Wetting of Filtercake

As used herein, a wet or wetted surface or the wetting of a surface may refer to a different liquid phase that is directly in contact with and adhered to the surface of a solid body. For example, the liquid phase can be an oleaginous film on the surface of particulate in a filtercake on the borehole or in the matrix material of a subterranean formation.

Some fluids can form such a film or layer on a downhole surface, which can have undesirable effects. The fluid (or a liquid component of the fluid) can form a film or layer on the surface, which can act as a physical barrier between the material of the underlying solid body and a fluid adjacent to the surface of the solid body. In effect, such a film presents a different wettability characteristic than the material of the underlying solid body.

If a filtercake is formed with an oil-based fluid, for example, with an oil-based drilling mud, the filtercake may be in an oil-wet condition. In such cases, it is desirable to change the filtercake material from an oil-wet condition to a water-wet condition by washing away the oleaginous material in the filtercake and on the particulate therein.

A water-based treatment fluid containing a surfactant can be used to change the condition of a filtercake from oil wet to water wet.

Suitable acid-compatible surfactants are preferably non-damaging to the subterranean formation. Specific examples of suitable acid-compatible surfactants that may be used in the compositions and methods of the present invention include fatty betaines that are dispersible in oil. Of the suitable fatty betaines, preferably carboxy betaines may be chosen because they are more acid sensitive. Specific examples of such betaines include lauramidopropyl betaine. Other suitable surfactants include ethylene oxide propylene oxide (“EO/PO”) block copolymers. Yet other suitable surfactants include fatty amines and fatty polyamines with HLB values of from about 3 to about 10. Suitable hydrophobically modified polyamines can include, but are not limited to, ethoxylated and propoxylated derivatives of these. Specific examples include ethoxylated tallow triamine. An ethoxylated tallow triamine is currently available as “GS 22-89W”™ from Special Products and ethoxylated oleyl amine currently available from AKZO Nobel as “ETHOMEEN S/12”™. Examples of suitable fatty polyamines include, but are not limited to, soya ethylenediamine, and tallow diethylene triamine. Suitable fatty amine examples include, but are not limited to, soya amine. Hydrophobically modified fatty amine examples include ethoxylated soya amines. In some instances, lauramidopropyl betaine may be preferred. Lauramidopropyl betaine is currently available commercially as “AMPHOSOL™ LB” from Stepan Company. In other instances, an EO/PO block copolymer may be preferred. A block copolymer of ethylene oxide and propylene oxide is currently available commercially as “SYNPERONIC™ PE/L64” from Uniqema.

The acid-compatible surfactant can be included in an amount of up to about 100% of a surfactant wash treatment fluid of the present invention, if desired. Suitable amounts for most cases may be from about 0.1% to about 20%, depending on the circumstances. However, using 5% or less is generally preferred and suitable under most circumstances. In certain embodiments, the acid-compatible surfactant may be included in a surfactant wash treatment fluid of the present invention in amount of from about 0.5 to about 4% of the surfactant wash treatment fluid. Considerations that may be taken into account when deciding how much to use include the amount of solids that will need to be degraded and the diameter of the wellbore. Other considerations may be evident to one skilled in the art with the benefit of this disclosure.

### Method Steps

As discussed above, the method can include the step of selecting the filtercake treatment interval to be treated. In addition, the method can include the step of selecting a suitable acid-producing microorganism for the filtercake treatment interval.

According to an embodiment of the invention, a method of treating a well is provided, the method including the steps of: forming one or more treatment fluids according to the invention; and introducing the one or more treatment fluids into the well.

The preparation of bacteria and nutrient mixtures is a well-established commercial process utilizing low cost raw materials, and is widely used in many industry segments for various purposes. Hence, the present invention can be a cost effective and commercially viable technology. It is also contemplated that a suitable nutrition may already be present in the wellbore or can be introduced separately.

The treatment fluid can additionally include an electron acceptor for respiration of the microorganism. It is also contemplated that a suitable electron acceptor may already be present in the wellbore or can be introduced separately.

In certain embodiments, the treatment fluid can include a viscosity-increasing agent, and it can additionally include a cross-linker for the viscosity-increasing agent.

In certain embodiments, the treatment fluid can include a strong or weak acid, which can be used, for example, to help break the filtercake.

In certain embodiments, the treatment fluid can include a corrosion inhibitor.

A well fluid can be prepared at the job site, prepared at a plant or facility prior to use, or certain components of the well fluid can be pre-mixed prior to use and then transported to the job site. Certain components of the well fluid may be provided as a “dry mix” to be combined with fluid or other components prior to or during introducing the well fluid into the well.

In certain embodiments, the preparation of a well fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Often the step of delivering a well fluid into a well is within a relatively short period after forming the well fluid, e.g., less within 30 minutes to one hour. More preferably, the step of delivering the well fluid is immediately after the step of forming the well fluid, which is “on the fly.”

It should be understood that the step of introducing a well fluid into a well can advantageously include the use of one or more fluid pumps.

In an embodiment, the step of introducing a treatment fluid including the acid-producing microorganism is at a rate and pressure below the fracture pressure of a treatment zone.

After the step of introducing a well fluid comprising an acid or acid-generating microorganism, the step of shutting in the subterranean formation allows time for the growth of the microorganism in the wellbore, for the generation of the acid by the microorganism, and for the released acid to attack carbonate or material subject to hydrolysis in the filtercake. For example, it is expected that the acid-producing microorganism, in the presence of sufficient nutrient for fermentation and sufficient electron-acceptor for respiration, will require at least 3 days to produce substantial concentrations of acid in the filtercake. It may be 5 days or more. Preferably, the step of flowing back is within 30 days of the step of introducing the microorganism. More preferably, within about 7 days of the step of introducing.

In an embodiment, the treatment fluid including the acid-producing microorganism additionally includes a corrosion inhibitor. The treatment fluid can additionally include a corrosion inhibitor intensifier. Of course, the corrosion inhibitor or corrosion inhibitor intensifier should not be harmful to the acid-producing microorganism.

Preferably, after any such well treatment, a step of producing hydrocarbon from the subterranean formation is the desirable objective.

It should also be understood that the step from introducing the microorganism through the step of shutting in should avoid introducing into the wellbore any biocidal concentration of any biocide to the acid-producing microorganism.

It should be understood that these steps can optionally be separate or combined as practical. For example, the step of treating the formation with the acid-producing microorganism can be performed with a fluid including the nutrition, or the nutrition can be introduced separately. Preferably, the microorganism and the nutrition are introduced together in the same treatment fluid.

It should also be understood that the steps can be performed in any practical sequence.

These and other possible sub-combinations according to the invention will be understood and appreciated by those of skill in the art with the benefit of the disclosure of the inventive concepts.

### CONCLUSION

Therefore, the present invention is well adapted to attain the ends and advantages mentioned as well as those that are inherent therein.

The exemplary fluids disclosed herein may directly or indirectly affect one or more components or pieces of equipment associated with the preparation, delivery, recapture, recycling, reuse, or disposal of the disclosed fluids. For example, the disclosed fluids may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary fluids. The disclosed fluids may also directly or indirectly affect any transport or delivery equipment used to convey the fluids to a well site or downhole such as, for example, any transport vessels, conduits, pipelines, trucks, tubulars, or pipes used to fluidically move the fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, or combinations thereof, and the like. The disclosed fluids may also directly or indirectly affect the various downhole equipment and tools that may come into contact with the chemicals/fluids such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope of the present invention.

The various elements or steps according to the disclosed elements or steps can be combined advantageously or practiced together in various combinations or sub-combinations of elements or sequences of steps to increase the efficiency and benefits that can be obtained from the invention.

It will be appreciated that one or more of the above embodiments may be combined with one or more of the other embodiments, unless explicitly stated otherwise.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

What is claimed is:

1. A method of degrading a filtercake in an interval of a wellbore penetrating a subterranean formation, wherein the filtercake comprises a gelled or solid material that can be dissolved or hydrolyzed with an acidic fluid, the method comprising the steps of:
(A) introducing a treatment fluid into the interval of the wellbore, the treatment fluid comprising: (i) water; and (ii) an acid-producing anaerobic microorganism; and then
(B) shutting in the interval of the wellbore.

2. The method according to claim 1, wherein the step of introducing the treatment fluid is at a rate and pressure below the fracture pressure of the subterranean formation.

3. The method according to claim 1, wherein the treatment fluid additionally comprises nutrition for the microorganism.

4. The method according to claim 3, wherein the nutrition is selected from the group consisting of: (a) a sugar; (b) a glycolate; (c) a water-soluble polysaccharide; (d) a water-soluble polysaccharide with an enzymatic breaker for the polysaccharide; and (e) any combination of the foregoing.

5. The method according to claim 1, wherein the treatment fluid additionally comprises one or more water-soluble acids having a pKa(1) in water of less than 5 and that are in sufficient concentration such that the water has a pH less than 4.

6. The method according to claim 1, wherein the treatment fluid additionally comprises an electron acceptor for respiration of the microorganism.

7. The method according to claim 1, wherein the microorganism is an extremophile wherein the microorganism is capable of living at a temperature above 60° C.

8. The method according to claim 7, wherein the microorganism is selected from the group consisting of: Enterobacteriaceae, Escherichia Coli, Serratia marcescens, Pseudomonas putida, and Klebsiella pneumoniae, and any combination thereof.

9. The method according to claim 1, wherein the design temperature during the step of shutting in is in the range of 60° C. to 121° C.

10. The method according to claim 1, further comprising the step of: after the step of shutting in, the step of flowing back a fluid from the subterranean formation to the wellbore.

11. A method of drilling and completing an openhole wellbore, the method comprising the steps of:
(A) drilling with an oil-based drilling fluid to form a borehole of a wellbore penetrating a subterranean formation, wherein a filtercake in an oil-wet condition is formed on the borehole of the wellbore; and then
(B) introducing a first treatment fluid into the wellbore wherein the first treatment fluid comprises a surfactant to change the filtercake to be water wet; and then
(C) introducing a second treatment fluid into the wellbore, the second treatment fluid comprising: (i) water; and (ii) an acid-producing anaerobic microorganism; and then
(D) shutting in the interval of the wellbore.

12. The method according to claim 11, wherein the surfactant is acid-compatible.

13. The method according to claim 11, wherein the surfactant comprises a surfactant chosen from the group consisting of: fatty betaines; carboxy betaines; lauramidopropyl betaine; ethylene oxide propylene oxide block copolymers; fatty amines; fatty polyamines; hydrophilically modified amines; ethoxylated derivatives of hydrophilically modified amines; ethoxylated derivatives of polyamines; propoxylated derivatives of hydrophilically modified amines; propoxylated derivatives of polyamines; ethoxylated tallow triamine; ethoxylated oleyl amine; soya ethylenediamine; tallow diethylene triamine; soya amines; ethoxylated soya amines; and derivatives or combinations of these.

14. The method according to claim 11, wherein the step of introducing the second treatment fluid is at a rate and pressure below the fracture pressure of the subterranean formation.

15. The method according to claim 11, wherein the second treatment fluid additionally comprises nutrition for the microorganism.

16. The method according to claim 15, wherein the nutrition is selected from the group consisting of: (a) a sugar; (b) a glycolate; (c) a water-soluble polysaccharide; (d) a water-soluble polysaccharide with an enzymatic breaker for the polysaccharide; and (e) any combination of the foregoing.

17. The method according to claim 11, wherein the second treatment fluid additionally comprises: one or more water-soluble acids having a pKa(1) in water of less than 5 and that are in sufficient concentration such that the water has a pH less than 4.

18. The method according to claim 11, wherein the second treatment fluid additionally comprises: an electron acceptor for respiration of the microorganism.

19. The method according to claim 11, wherein the microorganism is an extremophile wherein the microorganism is capable of living at a temperature above 60° C.

20. The method according to claim 19, wherein the microorganism is selected from the group consisting of: Enterobacteriaceae, Escherichia Coli, Serratia marcescens, Pseudomonas putida, and Klebsiella pneumoniae, and any combination thereof.
